(19) United States
(12) Patent Application Publication
(10) Pub. No.: US 2025/0059803 A1
(43) Pub. Date: Feb. 20, 2025

(54) MOTOR VEHICLE LOCK

(71) Applicant: Brose Schliesssysteme GmbH & Co. Kommanditgesellschaft, Wuppertal (DE)

(72) Inventor: Frank Hoerschgen, Solingen (DE)

(21) Appl. No.: 18/578,505

(22) PCT Filed: Jul. 13, 2022
(86) PCT No.: PCT/EP2022/069528

§ 371 Date: Jan. 11, 2024

(30) Foreign Application Priority Data
Jul. 15, 2021 (DE) 10 2021 118 349.9

(51) Int. Cl. E05B 81/20; E05B 81/06; E05B 81/66

(52) U.S. Cl. CPC E05B 81/20; E05B 81/06; E05B 81/66

(57) ABSTRACT

A motor vehicle lock having a lock catch and having a pawl arrangement, the lock having a pushing-open arrangement, by means of which the motor vehicle door in the installed state can be pushed open in a pushing-open operation and thus an access gap can be created between the door and a motor vehicle body, and a power-closing arrangement, by means of which the lock catch in the installed state can be adjusted, in a power-closing operation, in its closing direction, the lock, in the installed state, being coupled or couplable in terms of drive to a drive arrangement, and the lock having a coupling arrangement with two coupling states which are switchable such that a drive movement of the drive arrangement is transmitted either to the pushing-open arrangement, in order to perform a pushing-open operation, or to the power-closing arrangement, in order to perform a power-closing operation.

### CROSS-REFERENCE TO RELATED APPLICATIONS

This application is a national stage application under 35 U.S.C. 371 of International Patent Application Serial No. PCT/EP2022/069528, entitled “Motor Vehicle Lock,” filed Jul. 13, 2022, which claims priority from German Patent Application No. DE 10 2021 118 349.9, filed Jul. 15, 2021, the disclosure of which is incorporated herein by reference.

### FIELD OF THE TECHNOLOGY

Embodiments relate to a motor vehicle lock for a motor vehicle door, to a motor vehicle lock arrangement, to a motor vehicle closing system, to a motor vehicle door arrangement, and to a sensor arrangement.

### BACKGROUND

The known motor vehicle lock (DE 10 2018 126 968 A1) from which some embodiments proceed has a locking mechanism consisting of a lock catch and a pawl arrangement having a single pawl. The lock catch can be placed in holding engagement with a lock striker. In order to increase convenience, the known motor vehicle lock is equipped with a pushing-open arrangement by means of which the motor vehicle door can be adjusted, in a pushing-open operation, from a closed door position into a pushed-open door position. In order to further increase convenience, the known motor vehicle lock is equipped with a power-closing arrangement by means of which the lock catch can be adjusted from a pre-closing position into a main closing position. The two aforementioned convenience functions may be coupled to the same drive in order to perform a pushing-open operation or a power-closing operation. For this purpose, a coupling arrangement is provided, having a coupling lever which is adjustable, by means of a separate drive, into two coupling states.

### SUMMARY

The structural design of the known motor vehicle lock is space-saving in principle owing to the fact that the two convenience functions are actuated by means of the same drive. A challenge however consists in reliably preventing a pushing-open operation when the lock catch is situated in a closing position, in order to avoid damage to the motor vehicle lock.

The problem on which some embodiments are based is that of developing and refining the known motor vehicle lock such that operational reliability is increased.

The above problem is solved, in the case of a motor vehicle lock according to the disclosure.

The motor vehicle lock in question may be used in all types of motor vehicle doors. Here, the term “motor vehicle door” is to be understood broadly. In particular, it includes side doors, rear doors, tailgates, trunk lids or engine hoods. In this context, a motor vehicle door may in principle also be designed in the form of a sliding door.

An aspect of some embodiments is that of the coupling arrangement being coupled—directly or indirectly—to the pawl arrangement, such that the switching of the coupling arrangement into its coupling states is dependent on the state of the pawl arrangement. It can thus be ensured that the coupling arrangement allows a drive movement of the drive arrangement to be transmitted to the pushing-open arrangement, in order to perform a pushing-open operation, only when the pawl arrangement is in its release state. In the release state, the pawl arrangement releases the lock catch, whereby said lock catch is transferred into its open position. It is thus ensured that the lock catch is opened when a drive movement of the drive arrangement is transmitted to the pushing-open arrangement in order to perform a pushing-open operation, whereby operational reliability is increased.

Specifically, it is very generally proposed that the coupling arrangement is coupled or couplable to the pawl arrangement such that the coupling arrangement can, depending on the state of the pawl arrangement, be transferred into one of the coupling states, which is respectively associated with said state.

In various embodiments, a transmission of a drive movement of the drive arrangement to the pushing-open arrangement requires the pawl arrangement to be mechanically transferred into its release state, and/or a transmission of a drive movement of the drive arrangement to the power-closing arrangement requires the pawl arrangement to be mechanically transferred into its blocking state. It is thus ensured that the pushing-open operation can be performed only when the lock catch is in the open position, and the power-closing operation can be performed only when the lock catch is in the closing position, in particular pre-closing position.

In various embodiments, the motor vehicle lock has an opening device that is designed to transfer the pawl arrangement into the release state by motor means. The motor vehicle lock thus has a further convenience function.

In various embodiments, the coupling arrangement is coupled to the opening device. Indirect coupling of the coupling arrangement to the pawl arrangement is thus provided. The opening device is then coupled or couplable to the coupling arrangement and to the pawl arrangement. The state of the pawl arrangement can then be determined indirectly from the state of the opening device.

In various embodiments, the pawl arrangement has at least two, in particular three, pawls which interact with one another in order to block the lock catch in its respective closing position. Therefore, only a low force is required to transfer the pawl arrangement into its release state, whereby an acoustically quiet locking mechanism is created.

In various embodiments, one pawl, in particular the third pawl, and the disengaging lever are arranged coaxially. Pivoting of the disengaging lever then causes a disengagement of the pawl. A reliable and space-saving design can thus be achieved.

In various embodiments, the coupling arrangement has an at least substantially linearly adjustable coupling element that is adjustable by means of the opening device. A simple and robust switching mechanism of the coupling arrangement can thus be realized.

In various embodiments, the motor vehicle lock has an actuating lever that is coupled to the separate drive arrangement. The power-closing lever is arranged pivotably on the actuating lever and can be moved into two positions, in which pivoting of the actuating lever causes either a power-closing operation or a power-opening operation. An at least substantially linear adjustment of the coupling element causes the power-closing lever to pivot.

In various embodiments, the power-closing lever, in its power-opening position, is couplable to a transmission lever, which is in turn operatively connected to the pushing-open lever. Pivoting of the transmission lever then initiates a power-opening operation. The power-closing lever thus performs a coupling function in order to initiate a pushing-open operation.

In various embodiments, the motor vehicle lock has a sensor arrangement for identifying at least one lock catch position of the lock catch. It can thus be achieved that the separate drive arrangement is actuatable or activatable only if the lock catch is in its open position, for the purposes of performing a power pushing-open operation, or in its pre-closing position, for the purposes of performing a power-opening operation, whereby operational reliability is improved. The sensor arrangement can have three sensors in order to be able to detect the position of the lock catch, of the first pawl and of a further one of the pawls, in particular of the third pawl. This arrangement of three sensors makes it possible to precisely and reliably detect all relevant closing states of the locking mechanism consisting of lock catch and pawl arrangement.

According to various embodiments, a motor vehicle lock arrangement is provided, having a motor vehicle lock as proposed and having a closing element, in particular a lock striker, with which the lock catch of the motor vehicle lock can be placed in holding engagement. Reference may be made in this respect to all statements made regarding the motor vehicle lock as proposed.

According to various embodiments, a motor vehicle closing system is provided, having a motor vehicle lock as proposed or having a motor vehicle lock arrangement as proposed, having a drive arrangement that is separate from the motor vehicle lock or from the motor vehicle lock arrangement, and having a Bowden cable that couples the motor vehicle lock or the motor vehicle lock arrangement in terms of drive to the drive arrangement. Reference may be made in this respect to all statements made regarding the motor vehicle lock as proposed and regarding the motor vehicle lock arrangement as proposed.

According to various embodiments, a motor vehicle door arrangement is provided, having a motor vehicle door and having a motor vehicle lock arrangement as described herein, which is assigned to the motor vehicle door. Reference may be made in this respect to all statements made regarding the motor vehicle lock arrangement as proposed.

According to various embodiments, a sensor arrangement for detecting closing states of a locking mechanism of a motor vehicle lock, in particular of a motor vehicle lock as proposed, is provided, the locking mechanism having a lock catch and a pawl arrangement with a first pawl, which in the closing state acts on the lock catch, and with a second pawl, which interacts with the first pawl in the closing state, and in particular with a third pawl, which interacts with the second pawl in the closing state. Reference may be made in this respect to all statements made regarding the motor vehicle lock as proposed.

An aspect of various embodiments is that the lock catch position, the position of the first pawl and the position of the further pawl, in particular of the third pawl, are monitored. In this way, all relevant closing states of the locking mechanism can be reliably detected. With such a sensor arrangement, common convenience functions, such as a pushing-open arrangement, a power-closing arrangement or an opening device, can be reliably operated, and undesired actuations of the convenience functions can be prevented. At the same time, further lock functions, such as antitheft or central locking functions, can be actively controlled and/or switched.

In particular, it is very generally proposed that the sensor arrangement has three sensors, a first sensor being assigned to the lock catch in order to detect the lock catch position, a second sensor being assigned to the first pawl in order to detect the pawl position of the first pawl, and a third sensor being assigned to a further one of the pawls, in particular the third pawl, in order to detect the pawl position of the further, in particular third, pawl. Then, in particular with two-stage sensors, it is for example possible to reliably detect, and distinguish from one another, an open position of the lock catch, in which the pawl arrangement is situated when in its release state, an open position of the lock catch, in which the pawl arrangement is situated in the blocking state, a pre-closing position, in which the pawl arrangement, in the blocking state, blocks the lock catch in its pre-closing position, and/or a main closing position, in which the pawl arrangement, in the blocking state, blocks the lock catch in its main closing position. Corresponding sensors are inexpensive.

Various embodiments provide a motor vehicle lock for a motor vehicle door, having a lock catch and having a pawl arrangement, the lock catch being movable from an open position into at least one closing position, in particular into a main closing position and into a pre-closing position, in order to hold the motor vehicle door in holding engagement with a closing element, in particular a lock striker, the pawl arrangement being movable into a blocking state, in which it holds the lock catch in the closing position, and into a release state, in which it releases the lock catch, the motor vehicle lock having a pushing-open arrangement with a pushing-open lever which is separate from the lock catch and by means of which the motor vehicle door in the installed state can be pushed open, in a pushing-open operation, from a closed door position into a pushed-open door position, and thus an access gap can be created between the motor vehicle door and a motor vehicle body, the pushing-open lever being designed and arranged that, in the installed state, it acts in particular directly on the closing element in order to push open the motor vehicle door, the motor vehicle lock having a power-closing arrangement with a power-closing lever by means of which the lock catch in the installed state can be adjusted, in a power-closing operation, in its closing direction, in particular from a pre-closing position into a main closing position, the motor vehicle lock, in the installed state, being coupled or couplable in terms of drive to a drive arrangement which can be separate from the motor vehicle lock, the motor vehicle lock having a coupling arrangement with two coupling states which are switchable such that, depending on the coupling state, a drive movement of the drive arrangement is transmitted either to the pushing-open arrangement, in order to perform a pushing-open operation, or to the power-closing arrangement, in order to perform a power-closing operation, wherein the coupling arrangement is coupled or couplable to the pawl arrangement such that the coupling arrangement can, depending on the state of the pawl arrangement, be transferred into one of the coupling states, which is respectively associated with said state.

In various embodiments, the coupling arrangement is mechanically coupled or couplable to the pawl arrangement such that a transfer of the pawl arrangement into its release state causes the coupling arrangement to be switched such that a drive movement of the drive arrangement is transmitted to the pushing-open arrangement in order to perform a pushing-open operation, and/or such that a transfer of the pawl arrangement into its blocking state causes the coupling arrangement to be switched such that a drive movement of the drive arrangement is transmitted to the power-closing arrangement in order to perform a power-closing operation.

In various embodiments, the motor vehicle lock has an opening device having a motor-type opening drive which is operatively connected to an opening lever which, in the course of an opening operation, is actuatable such that the pawl arrangement is transferred from the blocking state into the release state, the opening device being movable from a basic state, in which the opening device does not act on the pawl arrangement, or at any rate does not act so as to disengage the pawl arrangement, and the pawl arrangement is in its blocking state, into an opening state, in which the opening device disengages the pawl arrangement, in some embodiments, such that the opening lever, during the transition of the opening device from the basic state into the opening state, acts on a disengaging lever such that the pawl arrangement is transferred into its release state.

In various embodiments, the coupling arrangement is coupled to the opening device such that the coupling arrangement transmits a drive movement of the drive arrangement to the power-closing arrangement if the opening device is in its basic state, and/or such that the coupling arrangement transmits a drive movement of the drive arrangement to the pushing-open arrangement, in order to perform the pushing-open operation, if the opening device is situated in its opening state.

In various embodiments, the pawl arrangement has a first pawl, which is pivotable about a first pawl axis between an engaged position and a disengaged position and which, when the lock catch is in a closing position, is in the engaged position and in blocking engagement with the lock catch, a second pawl, which is pivotable about a second pawl axis between an engaged position and a disengaged position and which, when the lock catch is in a closing position, is in the engaged position and holds the first pawl in blocking engagement with the lock catch, and in particular a third pawl, which is pivotable about a third pawl axis between an engaged position and a disengaged position and which, when the lock catch is in a closing position, is in the engaged position and in blocking engagement with the second pawl, in some embodiments the first pawl is arranged pivotably on the second pawl.

In various embodiments, the disengaging lever is pivotable about the pawl axis of one of the pawls, in particular the third pawl axis of the third pawl, and is coupled or couplable to the opening device such that, during the transition of the opening device from the basic state into the opening state, the disengaging lever is pivoted, whereby the pawl, in particular the third pawl, is disengaged and the pawl arrangement is transferred into its release state.

In various embodiments, the coupling arrangement has a coupling element, and wherein the coupling element is at least substantially linearly adjustable by means of the opening device such that a transition of the opening device from the basic state into the opening state and vice versa causes an adjustment of the coupling element.

In various embodiments, the drive arrangement is coupled in terms of drive to an actuating lever of the motor vehicle lock, such as via a Bowden cable.

In various embodiments, the power-closing lever is arranged pivotably on the actuating lever, and wherein the power-closing lever is pivotable from a power-closing position, in which pivoting of the actuating lever causes a power-closing operation, into a power-opening position, in which pivoting of the actuating lever causes a power-opening operation.

In various embodiments, an at least substantially linear adjustment of the coupling element causes the power-closing lever to pivot from its power-closing position into its power-opening position.

In various embodiments, the power-closing lever, in its power-opening position, is couplable to a transmission lever of the pushing-open arrangement, which is operatively connected to the pushing-open lever such that pivoting of the transmission lever causes a power-opening operation.

In various embodiments, the motor vehicle lock has a sensor arrangement that is designed to identify an open position, a pre-closing position and a main closing position of the lock catch.

In various embodiments, the sensor arrangement has a first sensor for detecting at least one lock catch position, in particular the open position, the pre-closing position and/or the main closing position, of the lock catch, a second sensor for detecting at least one pawl position, in particular the engaged position and/or the disengaged position, of the first pawl, and a third sensor for detecting at least one pawl position, in particular the engaged position and/or the disengaged position, of a further one of the pawls, in particular of the third pawl.

Various embodiments provide a motor vehicle lock arrangement having a motor vehicle lock as described herein and having a closing element, in particular a lock striker, with which the lock catch of the motor vehicle lock can be placed in holding engagement.

Various embodiments provide a motor vehicle closing system having a motor vehicle lock as described herein or having a motor vehicle lock arrangement as described herein, having a drive arrangement that is separate from the motor vehicle lock or from the motor vehicle lock arrangement, and having a Bowden cable that couples the motor vehicle lock or the motor vehicle lock arrangement in terms of drive to the drive arrangement.

Various embodiments provide a motor vehicle door arrangement having a motor vehicle door and having a motor vehicle lock arrangement as described herein assigned to the motor vehicle door.

Various embodiments provide a sensor arrangement for detecting closing states of a locking mechanism of a motor vehicle lock, in particular of a motor vehicle lock as described herein, the locking mechanism having a lock catch and a pawl arrangement with a first pawl, which is pivotable about a first pawl axis between an engaged position and a disengaged position and which, when the lock catch is in a closing position, is in the engaged position and in blocking engagement with the lock catch, with a second pawl, which is pivotable about a second pawl axis between an engaged position and a disengaged position and which, when the lock catch is in a closing position, is in the engaged position and holds the first pawl in blocking engagement with the lock catch, and with in particular a third pawl, which is pivotable about a third pawl axis between an engaged position and a disengaged position and which, when the lock catch is in a closing position, is in the engaged position and in blocking engagement with the second pawl, wherein the sensor arrangement has three sensors, a first sensor being assigned to the lock catch in order to detect at least one lock catch position, in particular the open position, the pre-closing position and/or the main closing position, a second sensor being assigned to the first pawl in order to detect at least one pawl position of the first pawl, and a third sensor being assigned to a further one of the pawls, in particular the third pawl, in order to detect at least one pawl position of the further, in particular third, pawl.

### BRIEF DESCRIPTION OF THE DRAWINGS

Various aspects will be discussed in more detail below on the basis of a drawing, which illustrates merely exemplary embodiments. In the drawing:

FIG. 1 shows a perspective view of a motor vehicle lock as proposed for closing the associated motor vehicle door, having a pushing-open arrangement, having a power-closing arrangement and having an opening device for motor-powered opening of the motor vehicle lock,

FIG. 2 shows a schematic front view of the motor vehicle lock shown in FIG. 1, a) in a main latching position of the lock catch and b) during an opening operation, with the opening device situated in its opening position,

FIG. 3 shows a schematic rear view of the motor vehicle lock shown in FIG. 1 and FIG. 2, a) in a main latching position of the lock catch and b) during an opening operation,

FIG. 4 shows a schematic rear view of the motor vehicle lock shown in FIG. 1, a) at the start of a pushing-open operation and b) in the case of a pushing-open operation that has progressed further,

FIG. 5 shows a schematic rear view of the motor vehicle lock shown in FIG. 1, a) at the start of a closing operation, with the lock catch in its open position, and b) in the case of a closing operation that has progressed further, with the lock catch in its pre-latching position, and

FIG. 6 shows a schematic rear view of the motor vehicle lock shown in FIG. 5, a) in the case of a closing operation that has progressed further, with the power-closing lever in engagement with the lock catch, and b) at the end of the closing operation, with the lock catch in its closing position.

### DETAILED DESCRIPTION

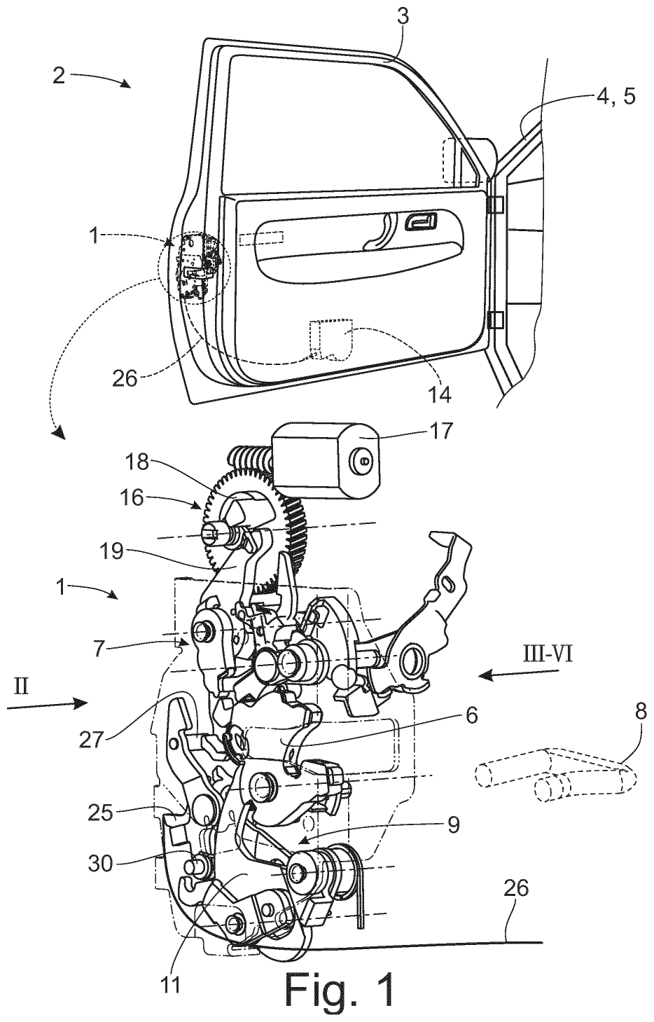

The motor vehicle lock 1 as proposed is part of a motor vehicle lock arrangement 2, as illustrated in FIG. 1. The motor vehicle lock arrangement 2 is assigned to a motor vehicle door 3, which is coupled to a motor vehicle body 4 of a motor vehicle 5. Here, the term “motor vehicle door” is to be understood broadly. In particular, it includes side doors, rear doors, tailgates, trunk lids or engine hoods. In this context, a motor vehicle door 3 may in principle also be designed in the form of a sliding door.

In various embodiments, the motor vehicle door 3 is a side door of a motor vehicle 5. All statements made in this regard apply correspondingly to all other types of motor vehicle doors.

The motor vehicle lock 1 assigned to the motor vehicle lock arrangement 2 is, when in the installed state illustrated, arranged on the motor vehicle door 3. Alternatively, in a manner not illustrated here, the motor vehicle lock 1 may, when in the installed state, be arranged on the motor vehicle body 4.

The motor vehicle lock 1 has a lock catch 6 and pawl arrangement 7 as lock components, and the lock catch 6 can, in order to hold the motor vehicle door 3, be placed in holding engagement with a closing element 8, in various embodiments a lock striker. In the situation illustrated in FIG. 1, the closing element 8 is arranged on the vehicle body 4. In the case (not illustrated here) of a motor vehicle lock 1 arranged on the motor vehicle body 4, the closing element 8 is arranged on the motor vehicle door 3.

In various embodiments, the lock catch 6 can be moved from an open position into a pre-closing position and a main closing position, also referred to as pre-latching position and main latching position.

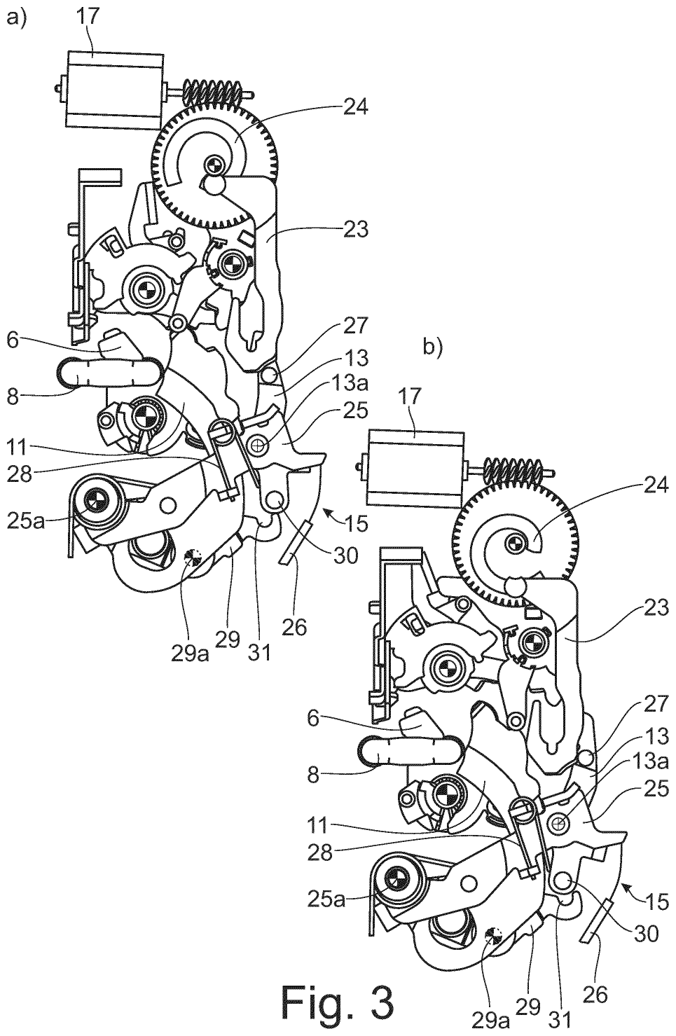

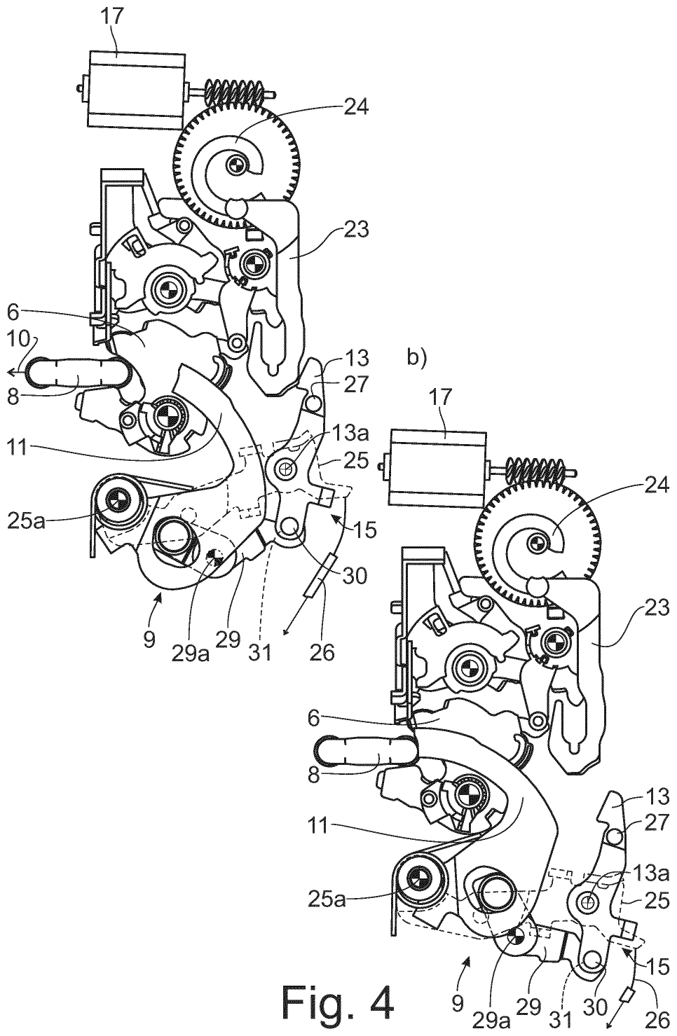

The motor vehicle lock 1 as proposed has a pushing-open arrangement 9 for exerting a drive force on the motor vehicle door 3 in the opening direction 10 thereof (FIG. 4). The pushing-open arrangement 9 has a pushing-open lever 11 which is separate from the lock catch 6 and by means of which the motor vehicle door 3 in the installed state can be pushed open, in a pushing-open operation, from a closed door position into a pushed-open door position, and thus an access gap can be created between the motor vehicle door 3 and the motor vehicle body 4, into which access gap the user can place a hand in order to manually fully open the motor vehicle door 3. Here, before the pushing-open arrangement 9 starts the pushing-open operation, the pawl arrangement 7 is disengaged, in various embodiments by motor means, from its blocking state shown in FIG. 3a), in which it blocks an opening of the lock catch 6 situated in its main closing position.

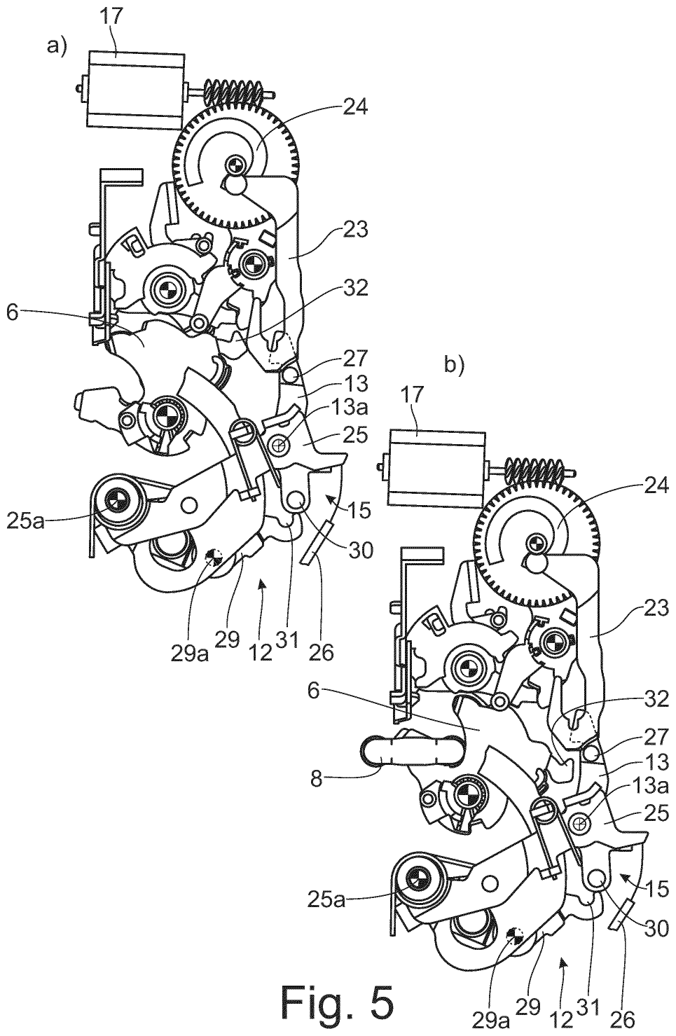

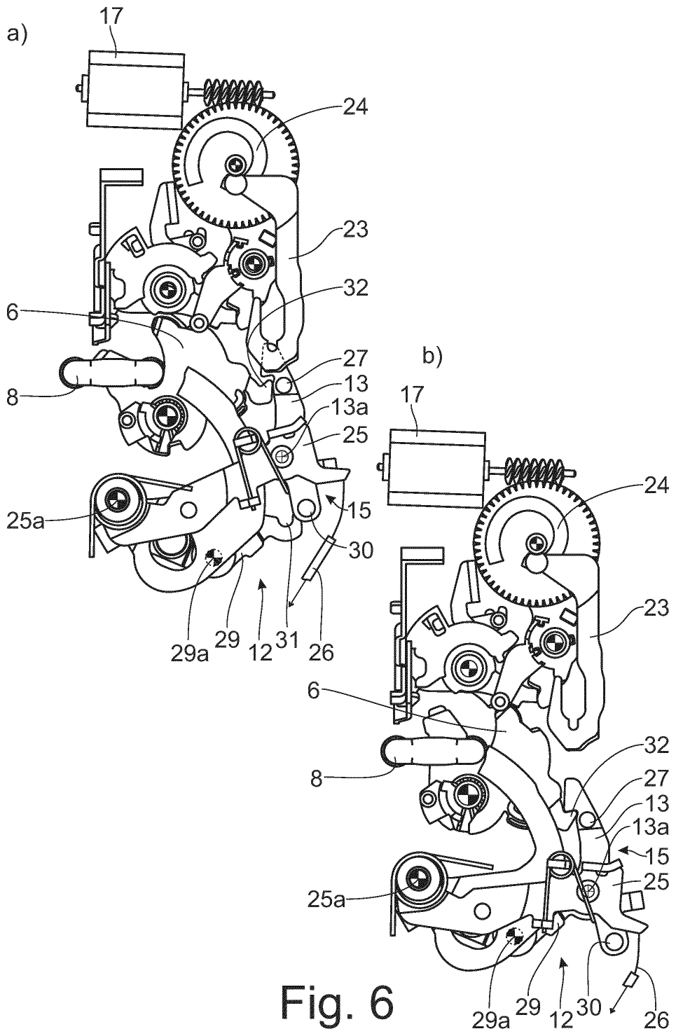

The motor vehicle lock 1 has a power-closing arrangement 12 having a power-closing lever 13 by means of which the lock catch 6 in the installed state can be adjusted, in a power-closing operation, in its closing direction, in particular from a pre-closing position into a main closing position. In various embodiments, the lock catch 6 is adjustable from its pre-closing position shown in FIG. 5b) into its main latching position shown in FIG. 6).

The motor vehicle lock 1 is, in the installed state, coupled or couplable in terms of drive to a drive arrangement 14 (FIG. 1), which is in various embodiments separate from the motor vehicle lock 1.

The motor vehicle lock 1 furthermore has a coupling arrangement 15 which, in any case, has two coupling states. The coupling arrangement 15 is switchable such that, depending on the coupling state, a drive movement of the drive arrangement 14 is transmitted either to the pushing-open arrangement 9, in order to perform a pushing-open operation, or to the power-closing arrangement 12, in order to perform a power-closing operation. The coupling arrangement is switchable in order to effect either a pushing-open operation or a power-closing operation by means of the drive arrangement 14.

What is now fundamental is that the coupling arrangement 15 is coupled or couplable to the pawl arrangement 7 such that the coupling arrangement 15 can, depending on the state of the pawl arrangement 7, be transferred into one of the coupling states, which is respectively associated with said state.

The coupling between the pawl arrangement 7 and the coupling arrangement 15 may be implemented in terms of control technology or may be purely mechanical. It can thus be ensured that the coupling arrangement 15 allows a drive movement of the drive arrangement 14 to be transmitted to the pushing-open arrangement 9, in order to perform a pushing-open operation, only when the pawl arrangement 7 is in a corresponding state, in various embodiments in its release state. In the release state, the pawl arrangement 7 releases the lock catch 6, whereby said lock catch is transferred into its open position. It is thus ensured that the lock catch 6 is opened when a drive movement of the drive arrangement 14 is transmitted to the pushing-open arrangement 9 in order to perform a pushing-open operation, whereby the operational reliability of the motor vehicle lock 1 is increased.

In various embodiments, the coupling arrangement 15 is mechanically coupled or couplable to the pawl arrangement 7 such that a transfer of the pawl arrangement 7 into its release state causes the coupling arrangement 15 to be switched such that a drive movement of the drive arrangement 14 is transmitted to the pushing-open arrangement 9 in order to perform a pushing-open operation, and/or such that a transfer of the pawl arrangement 7 into its blocking state causes the coupling arrangement 15 to be switched such that a drive movement of the drive arrangement 14 is transmitted to the power-closing arrangement 12 in order to perform a power-closing operation. It is thus ensured that the pushing-open operation can be performed only when the lock catch 6 is open, whereby damage to the lock catch 1 resulting from an improperly performed pushing-open operation is prevented. A high level of operational reliability is thus realized purely by mechanical means.

In various embodiments, the motor vehicle lock 1 has an opening device 16 having a motor-type opening drive 17 which is operatively connected to an opening lever 18 that is actuatable in the course of an opening operation.

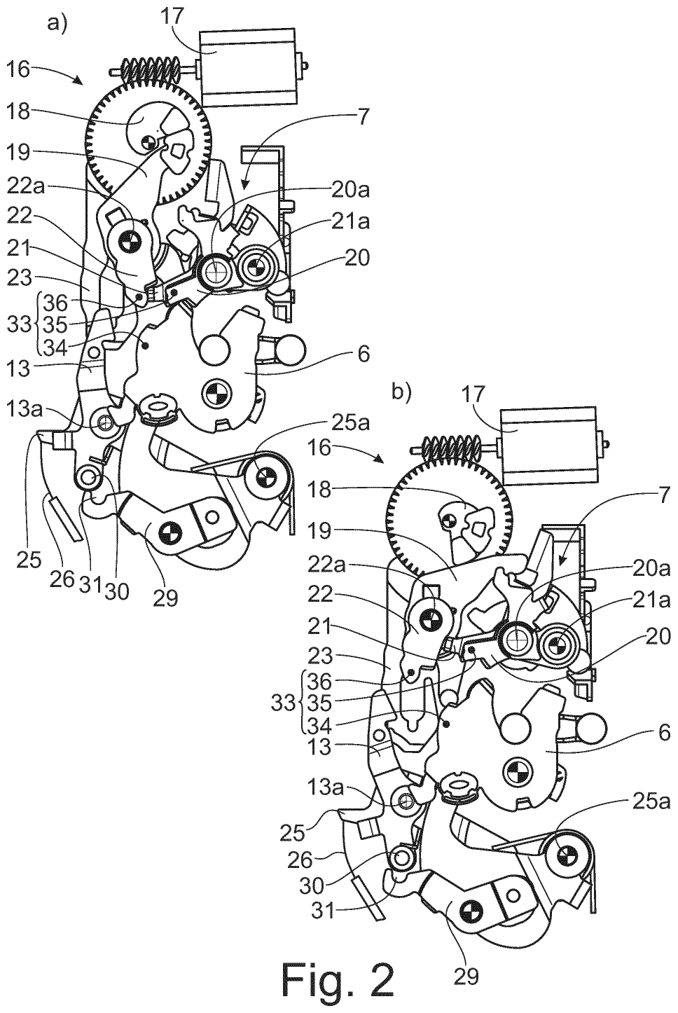

In various embodiments, the opening lever 18 is formed on a worm wheel which meshes with a worm arranged on a motor shaft of the opening drive 17. During an opening operation, the opening device 16 can be moved from a basic state (FIG. 2a) and FIG. 3a)), in which the opening device 16 does not act on the pawl arrangement 7, or at any rate does not act so as to disengage the pawl arrangement, and the pawl arrangement 7 is in its blocking state, into an opening state, in which the opening device 16 acts, via the opening device element 18, on a disengaging lever 19 such that the pawl arrangement 7 is transferred into its release state. If the opening lever 18 is pivoted, this leads to a pivoting movement of a disengaging lever 19, whereby the pawl arrangement 7 is transferred into its release state, as can be seen from a transition from FIG. 2a) to FIG. 2b).

Furthermore, the coupling arrangement 15 is in various embodiments coupled to the opening device 16 such that the coupling arrangement 15 transmits a drive movement of the drive arrangement 14 to the power-closing arrangement 12 if the opening device 16 is in its basic state, and/or such that the coupling arrangement 15 transmits a drive movement of the drive arrangement 14 to the pushing-open arrangement 9, in order to perform the pushing-open operation, if the opening device 16 is situated in its opening state. That is to say, a motor-powered adjustment of the opening device 16 mechanically causes an adjustment of the coupling arrangement 15, whereby mechanical coupling is realized between the opening device 16 and the coupling arrangement 15.

In various embodiments, the pawl arrangement 7 has a first pawl 20, which is pivotable about a first pawl axis 20a between an engaged position and a disengaged position. When the lock catch 6 is in a closing position, the first pawl 20 is in its engaged position and in blocking engagement with the lock catch 6. A further constituent part of the pawl arrangement 7 is a second pawl 21, which is pivotable about a second pawl axis 21a between an engaged position and a disengaged position. In various embodiments, the first pawl 20 is arranged pivotably on the second pawl 21. When the lock catch 6 is in a closing position, the second pawl 21 is in its engaged position and holds the first pawl 20 in blocking engagement with the lock catch 6. In various embodiments, the pawl arrangement 7 furthermore has a third pawl 22, which is pivotable about a third pawl axis 22a between an engaged position and a disengaged position. When the lock catch 6 is in a closing position, the third pawl 22 is in its engaged position and in blocking engagement with the second pawl 21. The state described here is shown in FIG. 2a). The third pawl 22, when in its disengaged position, releases the second pawl 21, whereby the second pawl 21, and in this case therefore also the first pawl 20, can also move into their respective disengaged positions. The lock catch 6 is thus released. The motor vehicle lock 1 thus has three pawls 20, 21, 22, whereby it is made possible for the pawl arrangement 7 to be disengaged using a low force, whereby, in turn, a particularly quiet locking mechanism is created.

In various embodiments, the disengaging lever 19 is pivotable about the third pawl axis 22a of the third pawl 22 and is coupled or couplable to the opening device 16 such that, during the transition of the opening device 16 from the basic state into the opening state, the disengaging lever 19 is pivoted, whereby the third pawl 22 is disengaged and the pawl arrangement 7 is transferred into the release state. In various embodiments, the disengaging lever 19 is coupled to the opening lever 18. A rotation of the opening lever 18 counterclockwise in FIG. 2 causes the disengaging lever 19 to be pivoted clockwise in FIG. 2. Here, the third pawl 22 is pivoted, together with the disengaging lever 19, counterclockwise, whereby the third pawl 22 disengages from the second pawl 21, whereby, in turn, the lock catch 6 is released, as can be seen when viewing FIG. 2a) and FIG. 2b) together.

In various embodiments, the coupling arrangement 15 has a coupling element 23, and the coupling element 23 is at least substantially linearly adjustable by means of the opening device 16 such that a transition of the opening device 16 from the basic state into the opening state and vice versa causes an adjustment of the coupling element 23. In various embodiments, the opening device has a control contour 24 with which the coupling element 23 interacts. In various embodiments, the control contour 24 is connected rotationally conjointly to the opening lever 18. “Connected” means mechanically connected, and encompasses frictional, form-fitting and/or integrally bonded connections, or a single-piece form of the unit consisting of opening lever 18 and control contour 24. In various embodiments, the opening lever 18, the control contour 24 and the worm wheel form a single-piece unit. As can be seen when viewing FIG. 3a) and FIG. 3b) together, when the worm wheel rotates clockwise, the control contour 24 interacts with the coupling element 23 such that the coupling element 23 is adjusted linearly downward in FIG. 3b).

Therefore, the coupling element 18 can be in various embodiments mechanically coupled to the opening device 16. At the same time, the coupling element 18 is thus in various embodiments also mechanically coupled via the opening device 16 to the pawl arrangement 7. The coupling element 18 is thus adjusted together with the pawl arrangement 7.

In various embodiments, the drive arrangement 14 is coupled in terms of drive to an actuating lever 25 of the motor vehicle lock 1. In various embodiments, the actuating lever 25 is coupled in terms of drive to the drive arrangement 14 via a Bowden cable 26. The Bowden cable 26 enables the drive movement to be redirected, thus allowing a flexible arrangement of the drive arrangement 14 relative to the motor vehicle lock 1.

In various embodiments, the power-closing lever 13 is arranged pivotably on the actuating lever 25, and the power-closing lever 13 is pivotable from a power-closing position, in which pivoting of the actuating lever 25 triggers a power-closing operation, into a power-opening position, in which pivoting of the actuating lever 25 triggers a power-opening operation. As shown in FIG. 3a), the power-closing lever 13 in various embodiments abuts with a guide pin 27 against the coupling element 23 when the drive arrangement 14 has not yet pivoted the actuating lever 25 via the Bowden cable 26. The power-closing lever 13 is in various embodiments preloaded counterclockwise in FIG. 2 by means of a spring 28. In FIG. 3a), the abutment of the guide pin 27 against the coupling element 23 prevents the power-closing lever 13 from pivoting further counterclockwise.

In various embodiments, an adjustment of the coupling element 23 causes the power-closing lever 13 to pivot from its power-closing position shown in FIG. 3a) into its power-opening position shown in FIG. 3b).

In FIG. 2a), the opening device 16 is in its basic state and the pawl arrangement 7 is in its blocking state. In FIG. 2a), the power-closing lever 13 is in its power-closing position.

In FIG. 2b), the opening device 16 is in its opening state. The pawl arrangement 7 is then in its release state. Owing to the fact that the coupling element 23 has been adjusted linearly downward in FIG. 2b), the power-closing lever 13 is in its power-opening position.

In various embodiments, the power-closing lever 13, in its power-opening position, can be placed in engagement with a transmission lever 29, which is operatively connected to the pushing-open lever 11 such that pivoting of the transmission lever 29 causes a power-opening operation. In various embodiments, the power-closing lever 13 has a transmission pin 30 which can move into a hook-like recess 31 of the transmission lever 29 and produce a mechanical connection between the power-closing lever 13 and the transmission lever 29, as shown in FIG. 3b) and FIG. 4a). Pivoting of the actuating lever 25 by means of the Bowden cable 26 then, via the power-closing lever 13 and the transmission lever 29, causes the pushing-open lever 11 to be pivoted.

In order to perform a pushing-open operation, the opening device 16 must firstly be transferred from its basic state (FIG. 3a)) into its opening state (FIG. 3b)). Here, at the same time, the pawl arrangement 7 is transferred from its blocking state (FIG. 3a)) into its release state (FIG. 3b)). The transition of the opening device 16 into its opening state causes the power-closing lever 13 to be transferred by the coupling element 23 into its power-opening position (FIG. 3b)). If the actuating lever 25 is then pivoted about its actuating lever axis 25a clockwise in FIG. 3b) by means of the Bowden cable 26, then the transmission pin 30 of the power-closing lever 13 engages with the hook-like recess 31 of the transmission lever 29, as can be seen from the transition from FIG. 3b) to FIG. 4a). The transmission lever 29 is in various embodiments of two-armed configuration and coupled to the pushing-open lever 11 such that pivoting of the actuating lever 25 clockwise in FIG. 4 causes the pushing-open lever 11 to pivot counterclockwise. Here, the pushing-open lever 11 engages with the closing element 8 (FIG. 4b)) and pushes the closing element 8 in an opening direction 10 of the motor vehicle door, whereby the aforementioned access gap is created between motor vehicle door 3 and motor vehicle body 4. In various embodiments, the actuating lever 25 and the pushing-open lever 11 are arranged coaxially.

In order to perform a power-closing operation, the opening device 16 must be in its basic state as shown in FIG. 5. If the lock catch 6 is transferred from its open position shown in FIG. 5a) into the pre-closing position shown in FIG. 5b) by virtue of the closing element 8 being placed in engagement with the lock catch 6 counter to the opening direction 10, the drive arrangement 14 can, via the Bowden cable 26, effect a power-closing operation. The power-closing lever 13 is in this case situated in its power-closing position as shown in FIG. 5 and FIG. 6. If, proceeding from a state in which the lock catch 6 is in its pre-closing position (FIG. 5b)), the actuating lever 25 is then pivoted clockwise in FIG. 6 about its actuating lever axis 25a, the spring 28 causes the power-closing lever 13 to pivot counterclockwise about the power-closing lever axis 13a, as can be seen from the transition from FIG. 5b) to FIG. 6a). As the actuating lever 25 pivots further, the power-closing lever 13 engages with a projection 32 of the lock catch 6, such that further pivoting of the actuating lever 25 causes the lock catch 6 to pivot clockwise in FIG. 6, whereby the lock catch 6 is transferred into its main latching position as shown in FIG. 6b).

To perform a power-closing operation or a pushing-open operation, the separate drive arrangement 14 is in various embodiments driven in the same direction in both cases, in order to initiate a pivoting movement of the actuating lever 25 by means of a tensile force introduced into the actuating lever 25. Depending on the state of the coupling arrangement 15, either a pushing-open operation or a power-closing operation is then initiated or performed. Here, the pushing-open operation takes place in the opening direction 10, and the power-closing operation takes place substantially in the opposite direction. That that is to say, a drive movement of the separate drive arrangement 14 that is performed in one direction is converted into opposite pushing-open or closing movements depending on the state of the coupling arrangement 15. The separate drive arrangement 14 can thus be actuated in a simple manner, because it is driven in each case only in one direction.

It is advantageous if the motor vehicle lock 1 has a sensor arrangement 33 that is designed to identify an open position, a pre-closing position and a main closing position of the lock catch 6 (FIG. 2).

In various embodiments, the sensor arrangement 33 has a first sensor 34 for detecting at least one lock catch position, in particular the open position, the pre-closing position and/or the main closing position, of the lock catch 6, a second sensor 35 for detecting at least one pawl position, in particular the engaged position and/or the disengaged position, of the first pawl 20, and a third sensor 36 for detecting at least one pawl position, in particular the engaged position and/or the disengaged position, of the third pawl 22. By means of the sensor arrangement 33, it is possible to reliably determine the open position of the lock catch 6 when the third pawl 22 is disengaged and when it is engaged, and to reliably determine the pre-closing position and the main closing position of the lock catch 6. Additionally, by means of the sensor arrangement 33, it is also possible to effectively identify instances of incorrect positioning of the locking mechanism consisting of lock catch 6 and pawl arrangement 7. It is then possible for the coupling arrangement 15 and/or the coupling element 23 to be adjusted by means of a separate drive or a separate actuator and thus for the coupling arrangement 15 to be transferred into its respective coupling states. This is advantageous inter alia if the motor vehicle lock 1 does not have a motor-powered opening device 16. At the same time, it is then possible to provide a reliable safeguard, in terms of circuitry, which prevents the drive arrangement 14 from being actuated when the motor vehicle lock 1 is not situated in a position that is suitable for the start of a power-closing operation or of a pushing-open operation. High operational reliability of a coupling in terms of control technology between the coupling arrangement 15 and the pawl arrangement 7 is thus also ensured.

In various embodiments, the sensors 34, 35, 36 are magnetically influenceable sensors 34, 35, 36, in some embodiments Hall sensors (FIG. 2). In various embodiments, in each case one permanent magnet is attached to the lock catch 6, to the first pawl 20 and to the third pawl 22, the magnetic fields of which permanent magnets influence in each case one Hall sensor such that the particular Hall sensor generates a sensor signal. In various embodiments, the Hall sensors are arranged at or on a motor vehicle lock housing of the motor vehicle lock 1. The closing position of the motor vehicle lock 1 can be precisely determined from the individual sensor signals.

According to further teaching that is of independent significance, a motor vehicle lock arrangement 2 is provided, having a motor vehicle lock 1 as proposed and having a closing element 8, in particular a lock striker, with which the lock catch 6 of the motor vehicle lock 1 can be placed in holding engagement. Reference may be made in this respect to all statements made regarding the motor vehicle lock 1 as proposed.

According to further teaching that is of independent significance, a motor vehicle closing system is provided, having a motor vehicle lock 1 as proposed or having a motor vehicle lock arrangement 2 as proposed, having a drive arrangement 14 that is separate from the motor vehicle lock 1 or from the motor vehicle lock arrangement 2, and having a Bowden cable 26 that couples the motor vehicle lock 1 or the motor vehicle lock arrangement 2 in terms of drive to the drive arrangement 14. Reference may be made in this respect to all statements made regarding the motor vehicle lock 1 as proposed and regarding the motor vehicle lock arrangement 2 as proposed.

According to further teaching that is of independent significance, a motor vehicle door arrangement is provided, having a motor vehicle door 3 and having a motor vehicle lock arrangement 2 as proposed, which is assigned to the motor vehicle door 3. Reference may be made in this respect to all statements made regarding the motor vehicle lock arrangement 2 as proposed.

According to further teaching that is of independent significance, a sensor arrangement 33 for detecting closing states of a locking mechanism of a motor vehicle lock 1, in particular of a motor vehicle lock 1 as proposed, is provided, the locking mechanism having a lock catch 6 and a pawl arrangement 7 with a first pawl 20, which is pivotable about a first pawl axis 20a between an engaged position and a disengaged position and which, when the lock catch 6 is in a closing position, is in the engaged position and in blocking engagement with the lock catch 6, with a second pawl 21, which is pivotable about a second pawl axis 21a between an engaged position and a disengaged position and which, when the lock catch 6 is in a closing position, is in the engaged position and holds the first pawl 20 in blocking engagement with the lock catch 6, and with in particular a third pawl 22, which is pivotable about a third pawl axis 22a between an engaged position and a disengaged position and which, when the lock catch 6 is in a closing position, is in the engaged position and in blocking engagement with the second pawl 21. Reference may be made in this respect to all statements made regarding the motor vehicle lock 1 as proposed.

What is now fundamental is that the sensor arrangement 33 has three sensors 34, 35, 36, a first sensor 34 being assigned to the lock catch 6 in order to detect at least one lock catch position, in particular the open position, the pre-closing position and/or the main closing position, a second sensor 35 being assigned to the first pawl 20 in order to detect at least one pawl position of the first pawl 20, and a third sensor 36 being assigned to a further one of the pawls 22, in particular the third pawl 22, in order to detect at least one pawl position of the further, in particular third, pawl 22.

As already discussed, each sensor 34, 35, 36 is in various embodiments a magnetically influenceable sensor 34, 35, 36 that generates sensor signals on the basis of a magnetic influence exerted by a magnetic field of a relevant permanent magnet. In various embodiments, in each case one permanent magnet is assigned to the lock catch 6, to the first pawl 20 and to the third pawl 22, said permanent magnets interacting with associated magnetically influenceable Hall sensors 34, 35, 36. In various embodiments, the magnetically influenceable sensors 34, 35, 36 are attached to a motor vehicle lock housing of the motor vehicle lock 1.

1. A motor vehicle lock for a motor vehicle door, comprising a lock catch and a pawl arrangement, the lock catch being movable from an open position into at least one closing position in order to hold the motor vehicle door in holding engagement with a closing element,
the pawl arrangement being movable into a blocking state, in which it holds the lock catch in the closing position, and into a release state, in which it releases the lock catch, the motor vehicle lock comprising a pushing-open arrangement with a pushing-open lever which is separate from the lock catch and by which the motor vehicle door in the installed state can be pushed open, in a pushing-open operation, from a closed door position into a pushed-open door position, and thus an access gap can be created between the motor vehicle door and a motor vehicle body, the pushing-open lever being designed and arranged that, in the installed state, it acts on the closing element in order to push open the motor vehicle door,
the motor vehicle lock comprising a power-closing arrangement with a power-closing lever by which the lock catch in the installed state can be adjusted, in a power-closing operation, in its closing direction,
the motor vehicle lock, in the installed state, being coupled or couplable in terms of drive to a drive arrangement,
the motor vehicle lock comprising a coupling arrangement with two coupling states which are switchable such that, depending on the coupling state, a drive movement of the drive arrangement is transmitted either to the pushing-open arrangement, in order to perform a pushing-open operation, or to the power-closing arrangement, in order to perform a power-closing operation,
wherein the coupling arrangement is coupled or couplable to the pawl arrangement such that the coupling arrangement can, depending on the state of the pawl arrangement, be transferred into one of the coupling states, which is respectively associated with said state.

2. The motor vehicle lock as claimed in claim 1, wherein the coupling arrangement is mechanically coupled or couplable to the pawl arrangement such that a transfer of the pawl arrangement into its release state causes the coupling arrangement to be switched such that a drive movement of the drive arrangement is transmitted to the pushing-open arrangement in order to perform a pushing-open operation, and/or such that a transfer of the pawl arrangement into its blocking state causes the coupling arrangement to be switched such that a drive movement of the drive arrangement is transmitted to the power-closing arrangement in order to perform a power-closing operation.

3. The motor vehicle lock as claimed in claim 1, wherein the motor vehicle lock has an opening device comprising a motor-type opening drive which is operatively connected to an opening lever which, in the course of an opening operation, is actuatable such that the pawl arrangement is transferred from the blocking state into the release state, the opening device being movable from a basic state, in which the opening device does not act on the pawl arrangement, or at any rate does not act so as to disengage the pawl arrangement, and the pawl arrangement is in its blocking state, into an opening state, in which the opening device disengages the pawl arrangement.

4. The motor vehicle lock as claimed in claim 3, wherein the coupling arrangement is coupled to the opening device such that the coupling arrangement transmits a drive movement of the drive arrangement to the power-closing arrangement if the opening device is in its basic state, and/or such that the coupling arrangement transmits a drive movement of the drive arrangement to the pushing-open arrangement, in order to perform the pushing-open operation, if the opening device is situated in its opening state.

5. The motor vehicle lock as claimed in claim 1, wherein the pawl arrangement has a first pawl, which is pivotable about a first pawl axis between an engaged position and a disengaged position and which, when the lock catch is in a closing position, is in the engaged position and in blocking engagement with the lock catch, a second pawl, which is pivotable about a second pawl axis between an engaged position and a disengaged position and which, when the lock catch is in a closing position, is in the engaged position and holds the first pawl in blocking engagement with the lock catch, and a third pawl, which is pivotable about a third pawl axis between an engaged position and a disengaged position and which, when the lock catch is in a closing position, is in the engaged position and in blocking engagement with the second pawl.

6. The motor vehicle lock as claimed in claim 5, wherein the disengaging lever is pivotable about the pawl axis of one of the pawls, and is coupled or couplable to the opening device such that, during the transition of the opening device from the basic state into the opening state, the disengaging lever is pivoted, whereby the pawl is disengaged and the pawl arrangement is transferred into its release state.

7. The motor vehicle lock as claimed in claim 1, wherein the coupling arrangement has a coupling element, and wherein the coupling element is at least substantially linearly adjustable by the opening device such that a transition of the opening device from the basic state into the opening state and vice versa causes an adjustment of the coupling element.

8. The motor vehicle lock as claimed in claim 1, wherein the drive arrangement is coupled in terms of drive to an actuating lever of the motor vehicle lock.

9. The motor vehicle lock as claimed in claim 8, wherein the power-closing lever is arranged pivotably on the actuating lever, and wherein the power-closing lever is pivotable from a power-closing position, in which pivoting of the actuating lever causes a power-closing operation, into a power-opening position, in which pivoting of the actuating lever causes a power-opening operation.

10. The motor vehicle lock as claimed in claim 9, wherein an at least substantially linear adjustment of the coupling element causes the power-closing lever to pivot from its power-closing position into its power-opening position.

11. The motor vehicle lock as claimed in claim 1, wherein the power-closing lever, in its power-opening position, is couplable to a transmission lever of the pushing-open arrangement, which is operatively connected to the pushing-open lever such that pivoting of the transmission lever causes a power-opening operation.

12. The motor vehicle lock as claimed in claim 1, wherein the motor vehicle lock has a sensor arrangement that is designed to identify an open position, a pre-closing position and a main closing position of the lock catch.

13. The motor vehicle lock as claimed in claim 12, wherein the sensor arrangement has a first sensor for detecting at least one lock catch position, in particular the open position, the pre-closing position and/or the main closing position, of the lock catch, a second sensor for detecting at least one pawl position, in particular the engaged position and/or the disengaged position, of the first pawl, and a third sensor for detecting at least one pawl position, in particular the engaged position and/or the disengaged position, of a further one of the pawls, in particular of the third pawl.

14. A motor vehicle lock arrangement comprising a motor vehicle lock as claimed in claim 1 and comprising a closing element with which the lock catch of the motor vehicle lock can be placed in holding engagement.

15. A motor vehicle closing system comprising a motor vehicle lock as claimed in claim 1, comprising a drive arrangement that is separate from the motor vehicle lock or from the motor vehicle lock arrangement, and comprising a Bowden cable that couples the motor vehicle lock or the motor vehicle lock arrangement in terms of drive to the drive arrangement.

16. A motor vehicle door arrangement comprising a motor vehicle door and comprising a motor vehicle lock arrangement as claimed in claim 14 assigned to the motor vehicle door.

17. A sensor arrangement for detecting closing states of a locking mechanism of a motor vehicle lock, the locking mechanism comprising a lock catch and a pawl arrangement with a first pawl, which is pivotable about a first pawl axis between an engaged position and a disengaged position and which, when the lock catch is in a closing position, is in the engaged position and in blocking engagement with the lock catch, with a second pawl, which is pivotable about a second pawl axis between an engaged position and a disengaged position and which, when the lock catch is in a closing position, is in the engaged position and holds the first pawl in blocking engagement with the lock catch, and with a third pawl, which is pivotable about a third pawl axis between an engaged position and a disengaged position and which, when the lock catch is in a closing position, is in the engaged position and in blocking engagement with the second pawl, wherein the sensor arrangement has three sensors, a first sensor being assigned to the lock catch in order to detect at least one lock catch position, the pre-closing position and/or the main closing position, a second sensor being assigned to the first pawl in order to detect at least one pawl position of the first pawl, and a third sensor being assigned to a further one of the pawls in order to detect at least one pawl position of the further pawl.

18. The motor vehicle lock as claimed in claim 1, wherein the drive arrangement which is separate from the motor vehicle lock.

19. The motor vehicle lock as claimed in claim 3, wherein the opening device disengages the pawl arrangement, such that the opening lever, during the transition of the opening device from the basic state into the opening state, acts on a disengaging lever such that the pawl arrangement is transferred into its release state.

20. The motor vehicle lock as claimed in claim 5, wherein the first pawl is arranged pivotably on the second pawl.
